(19) United States
(12) Patent Application Publication
(10) Pub. No.: US 2022/0356912 A1
(43) Pub. Date: Nov. 10, 2022

(54) Clutch Assembly and Improved Pressure Plate for Use in Clutch Assembly

(71) Applicant: Rekluse Racing, LLC, Boise, ID (US)

(72) Inventors: Sean Brown, Boise, ID (US); Karl Jensen, Boise, ID (US); Dayne Konrad, Boise, ID (US)

(21) Appl. No.: 17/316,236

(22) Filed: May 10, 2021

(51) Int. Cl. F16D 13/71; F16D 13/58; F16D 13/52; F16D 23/12

(52) U.S. Cl. CPC F16D 13/71; F16D 13/583; F16D 13/52; F16D 23/12; F16D 2023/126

(57) ABSTRACT

An improved pressure plate and clutch assembly allowing for use of a Bellevue (or diaphragm) spring and/or a series of coil springs in the clutch assembly. A Bellevue spring alone can be utilized with the pressure plate; a series of coil springs alone can be utilized with the pressure plate; or alternatively both a Bellevue spring and a series of coil springs can be utilized. The pressure plate has features that allow for either or both of the spring types to be utilized to bias the pressure plate. This allows for the selection of either spring type or both spring types. The pressure plate further preferably has features to allow for a spring or similar biasing mechanism to exert an opposing force to the Bellevue and/or series of coil springs.

### TECHNICAL FIELD

The presently disclosed technology relates to vehicle clutches, and more particularly to clutches with multi-plate clutch packs.

### BACKGROUND

This invention relates to a clutch system of the friction type placed in a power transmission system. Typical clutch systems include a clutch input such as a clutch basket, a clutch output such as a center clutch or clutch hub, and one or more plates making up a clutch pack and disposed between the clutch input and clutch output. When the clutch pack is compressed, the clutch input and clutch output become rotationally coupled.

A clutch pack is typically made up of two types of plates—driving plates and driven plates. Driving plates are commonly referred to as friction discs and are coupled rotationally to a clutch basket. A clutch basket is typically coupled to an input from a motor. Driven plates are commonly referred to as separator plates and are coupled rotationally to a clutch hub. Separator plates are commonly constructed of steel. A clutch hub is typically coupled to an output such as a transmission. Typically, such clutch systems include a clutch disengagement system utilizing of a clutch lever mechanically coupled to the pressure plate such that when the clutch lever is actuated, the pressure plate's compressive force on the clutch pack is removed, disconnecting the rotational coupling between the clutch input and clutch output. Clutch disengagement systems typically couple the clutch lever to the pressure plate mechanically through a hydraulic actuation system or a cable actuation system.

The clutch pack is typically compressed by a pressure plate; the pressure plate typically providing a compressive force via a spring mechanism or through a centrifugally actuated mechanism. The spring(s) of the spring mechanism act on the pressure plate to compress the clutch pack forcing the adjacent surfaces of the friction discs and drive plates to become coupled rotationally and in turn coupling the basket and center clutch rotationally. In typical motorcycle clutches the springs are either a Bellevue (also known as a diaphragm) spring or a series of coil springs. Typically the series of coil springs utilizes six coil springs. Each spring mechanism has its own

[symbol]

Typically a motorcycle clutch utilizes either a Belleville or series of coil springs. The advantage of a Belleville spring is that it provides a uniform pressure on the pressure plate. The advantage of the coil spring is that the coils can be replaced and the clutch can be effectively tuned easier by replacement of individual coil springs, as opposed to replacing the entirety of the Bellville spring. In general, each pressure plate currently available or known to the applicant is configured to operate with either a Belleville spring or a series of coil springs. Interchangeability and interoperability is not provided by the known art.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is an improved pressure plate for a vehicle clutch assembly operable with a clutch disengagement system. The improved pressure plate having a pressure plate having the shape of a disc. The pressure plate having features configured for operability with a diaphragm spring and a series of coil springs such that the diaphragm springs and coil springs are configured to exert a force on the pressure plate such that the pressure plate compresses a clutch pack of a vehicle clutch in which said pressure plate is utilized.

In a preferred embodiment the features include a circumferential flange extending inward from an outer circumference of said disc configured for receiving thereon a Bellevue spring. The features preferably include a series of coil spring cups formed or positioned radially inward in pressure plate from the circumferential flange. The coil spring cups are each configured for a coil spring and retaining bolt to be positioned through the coil spring cup.

Preferably the coil spring cups each has a compressive upper surface wherein said upper surface is configured for compressive interaction with the coil springs. This allows the coil springs to provide a compressive force to the pressure plate against a clutch pack of the clutch clutch. Preferably the coil spring cups comprise a lower compression surface. The lower compression surface is configured such that an opposing biasing member configured to exert an opposing force on the pressure plate to the diaphragm spring and coils springs. Preferably the opposing biasing member is a wave spring.

The pressure plate is configured for placement in a clutch assembly. This improved clutch assembly preferably includes a generally cylindrical clutch basket. The clutch basket has sidewalls, a closed first end and an open second end, and a series of fingers and slots between the fingers with the fingers and slots forming a circumferential wall of the clutch basket.

The clutch assembly includes plurality of driving friction disks mounted in said clutch basket. Each driving friction having a circular and planar disk with a hollow center portion. A plurality of positioning tabs extends out from a periphery of each driving friction disks. The positioning tabs are configured to extend between fingers of the clutch basket. Each driving friction disk is configured for frictional engagement with an adjacent driven friction disk.

The clutch assembly further includes a plurality of driven friction disks mounted in the clutch basket. Each driven friction disk has a circular and planar disk with a hollow center portion. A plurality of engagement tabs extends toward the center of each of the disks. The engagement tabs are for engagement with a center clutch which is configured to rotate in relation to said clutch basket. Each driven friction disk is configured for frictional engagement with an adjacent driving friction disk.

The clutch assembly includes an improved pressure plate having the shape of a disc. The pressure plate having features configured for operability with a diaphragm spring and a series of coil springs such that the diaphragm springs and coil springs are configured to exert a compressive force on the pressure plate to bias the clutch pack together to rotationally couple the center clutch and the clutch basket by the clutch pack. The pressure plate is configured to be operationally coupled to a clutch actuation system such that actuation by the clutch actuation system causes a reverse force on said pressure plate to overcome said bias of said diaphragm spring and/or said coil springs.

Preferably the clutch is configured for use with a clutch actuation system that utilizes a throw out rod operationally connected to a clutch actuation lever. The pressure plate has an opening at the center of the pressure plate that is defined by an annular ring formed in the pressure plate. The annular ring has a throw out bearing surface configured for engagement with a throw out bearing connected to the end of the throw out rod.

The improved clutch assembly can have at least one biasing device positioned between the center clutch and the clutch basket. The biasing device is configured to exert a force on the pressure plate opposite to the force exerted by the diaphragm spring and/or coil springs to reduce the force required to actuate the clutch with the clutch actuation system. In a preferred embodiment the biasing devices are a series of wave springs.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE FIGURES

FIG. 1 is an exploded view of a prior art clutch assembly utilizing coil springs.

FIG. 2 is a section view of the prior art clutch assembly of FIG. 1.

FIG. 3 is an exploded view of a prior art clutch assembly utilizing a Bellevue or diaphragm spring.

FIG. 4 is a section view of the prior art clutch assembly shown in FIG. 3.

FIG. 5 is an exploded view of a clutch assembly according to inventive concepts disclosed herein.

FIG. 6 is a section view of the clutch assembly shown in FIG. 5.

FIG. 7 is an exploded view of a clutch assembly according to inventive concepts disclosed herein.

FIG. 8 is a section view of the clutch assembly shown in FIG. 7.

FIG. 9 is an exploded view of a clutch assembly according to inventive concepts disclosed herein.

FIG. 10 is a section view of the clutch assembly shown in FIG. 9.

FIG. 11 is an exploded view of a clutch assembly according to inventive concepts disclosed herein.

FIG. 12 is a section view of the clutch assembly shown in FIG. 11.

FIG. 12a is a perspective section view of the clutch assembly shown in FIGS. 11-12.

FIG. 13 is a perspective view of a preferred embodiment of a clutch pressure plate according to inventive concepts disclosed herein.

FIG. 13a is a perspective view of a preferred embodiment of a clutch pressure plate according to inventive concepts disclosed herein.

### DETAILED DESCRIPTION OF THE FIGURES

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are typically identified with like reference numerals. The use of “e.g.,” “etc,” and “or” indicates non-exclusive alternatives without limitation unless otherwise noted. The use of “including” means “including, but not limited to,” unless otherwise noted.

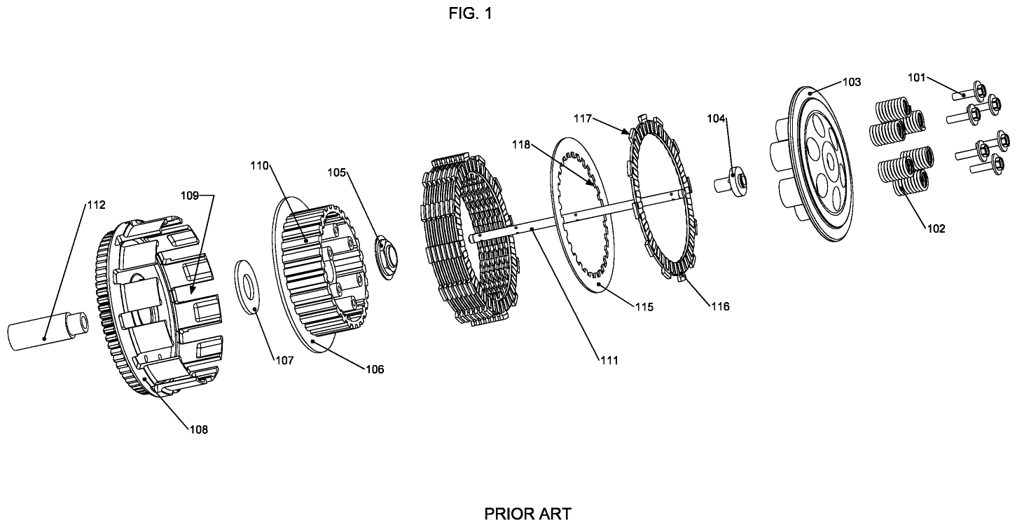

FIG. 1 is an exploded view of a standard prior art clutch. The configuration of the clutch basket 108, center clutch thrust washer 107, center clutch 106, transmission input shaft 112, center clutch nut 105, throw-out 104, throw out rod 111, friction disk 116, drive plate 115, pressure plate 103, standard springs 102 and spring bolts 101 are typical of most modern motorcycle clutches, this structure is commonly employed in many types of power transmission devices. Clutch pack 120 is comprised of friction disks 116 and drive plates 115. The clutch basket 108 contains slots 109 which receive the friction disk tabs 117 and thus coupling the clutch basket 108 and friction disks 116 rotationally. The center clutch 106 contains a profiled ring 110 which provides rotational coupling to the teeth 118 of the drive plates 115. The clutch basket 108 is typically coupled rotationally to a power input source such as an engine and the center clutch 106 is typically coupled rotationally to an output such as a transmission. In another embodiment the clutch basket 108 is coupled rotationally to an output and the center clutch 106 is coupled rotationally to a power input. Typically the clutch basket 108 contains an opening in the center for receiving a transmission input shaft 112; the clutch basket 108 is configured with a bearing between the clutch basket 108 and the transmission input shaft so that the clutch basket 108 can rotate independently of the transmission input shaft with minimal friction. Typically a center clutch thrust washer 107 is disposed between a center clutch 106 and the clutch basket 108. A center clutch nut 105 secures the center clutch 106 against the center clutch thrust washer 107 which in turn is secured against a shoulder on the transmission input shaft. The center clutch is typically rotationally coupled to the transmission input shaft via a suitable spline.

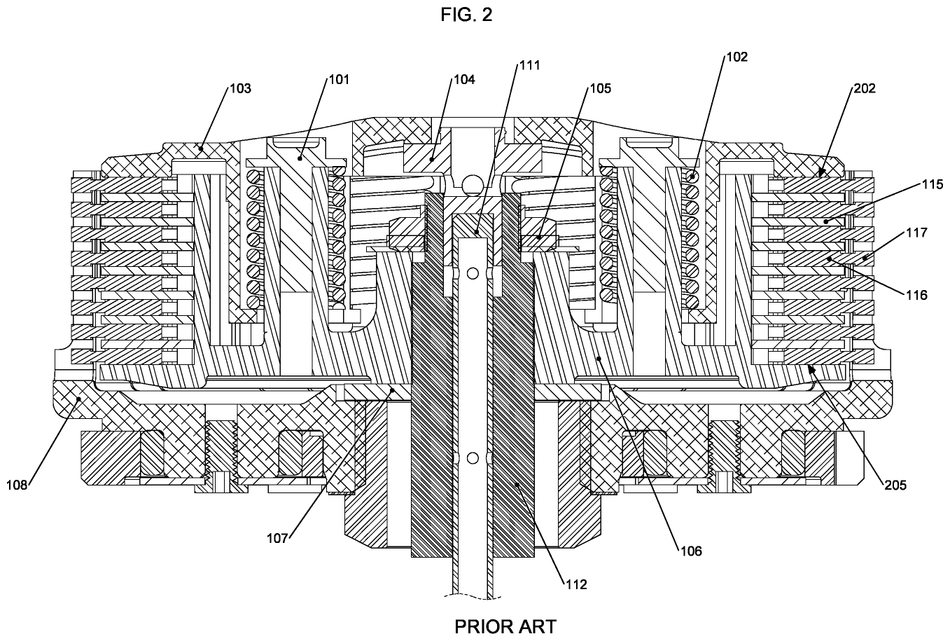

FIG. 2 is a section view of the prior art clutch shown in FIG. 1. As best seen in FIG. 1, the clutch pack 120 is comprised of eight friction disks 116 and seven drive plates 115. The clutch pack 120 establishes the distance between the pressure plate flange face 102 and center clutch flange face 105. The standard springs 102 act on the pressure plate 103 to compress the clutch pack 120 forcing the adjacent surfaces of the friction disks 116 and drive plates 115 to become coupled rotationally and in turn coupling the basket 108 and center clutch 106 rotationally. The throw-out 104 is coupled to a clutch disengagement system (not shown). The clutch disengagement system (not shown) is operable to selectively position the throw-out 104 for the purpose of pushing the pressure plate 103 away from the clutch pack 120 to disengage the clutch. The throw out 104 includes a bearing allowing the pressure plate to rotate relative to the throw out. The throw out 104 is attached dot the end of the throw out rod 111, which is operationally connected to the clutch actuation system. Alternatively, the clutch disengagement system (not shown) is operable to selectively position the throw-out 104 for the purpose of returning the pressure plate 103 into contact with the clutch pack 120 to engage the clutch. In another embodiment the clutch pack 120 is comprised of nine friction disks 116 and eight drive plates 115. In the preferred embodiment the clutch pack 120 is comprised of eight 3-millimeter thick friction disks 116 and seven 1.6-millimeter drive plates 115 resulting in the clutch pack 120 being approximately 35.2-millimeters tall. In other prior art the clutch pack 120 is less than 35-millimeters tall and is comprised of eight friction disks and seven drive plates that are less than 1.6-millimeters thick. In yet other prior art, the clutch pack 120 is taller than 35.2 millimeters and is comprised of nine friction disks which are approximately 4-millimeters thick and eight drive plates which are approximately 2-millimeters thick.

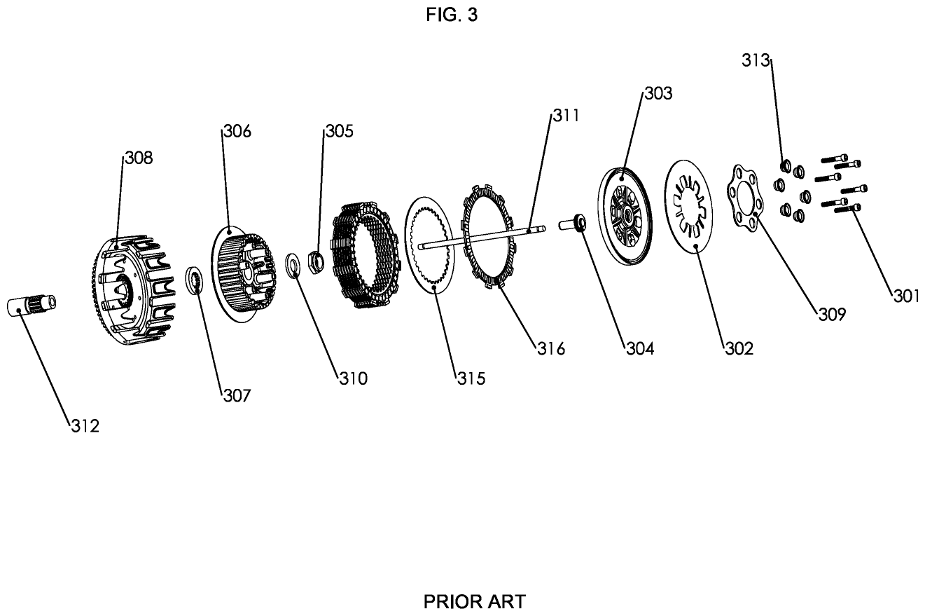

FIG. 3 is an exploded view of a prior art clutch utilizing a Bellevue spring for biasing the pressure plate of the clutch assembly. The configuration of the clutch basket 308, center clutch thrust washer 307, center clutch 306, gear 307, transmission input shaft 312, center clutch nut 305, center clutch nut washer 310, throw-out 304, friction disk 316, drive plate 315, pressure plate 303, Bellevue spring (or diaphragm spring) 302, spring hold down plate 309, spring seats 313, and spring bolts 301 are typical of most Bellevue motorcycle clutches. Clutch pack 320 is comprised of friction disks 316 and drive plates 315. The clutch basket 308 contains slots which receive the friction disk tabs and thus coupling the clutch basket 308 and friction disks 316 rotationally. The center clutch 306 contains a profiled ring which provides rotational coupling to the teeth of the drive plates 315. The clutch basket 308 is typically coupled rotationally to a power input source such as an engine and the center clutch 306 is typically coupled rotationally to an output such as a transmission. In another embodiment the clutch basket 308 is coupled rotationally to an output and the center clutch 306 is coupled rotationally to a power input. Typically the clutch basket 308 contains an opening in the center for receiving a transmission input shaft 312; the clutch basket 308 is configured with a bearing between the clutch basket 308 and the transmission input shaft so that the clutch basket 308 can rotate independently of the transmission input shaft with minimal friction. Typically a center clutch thrust washer 307 is disposed between a center clutch 306 and the clutch basket 318. A center clutch nut 305 secures the center clutch 306 against the center clutch thrust washer 307 which in turn is secured against a shoulder (not shown) on the transmission input shaft. The center clutch is typically rotationally coupled to the transmission input shaft via a suitable spline.

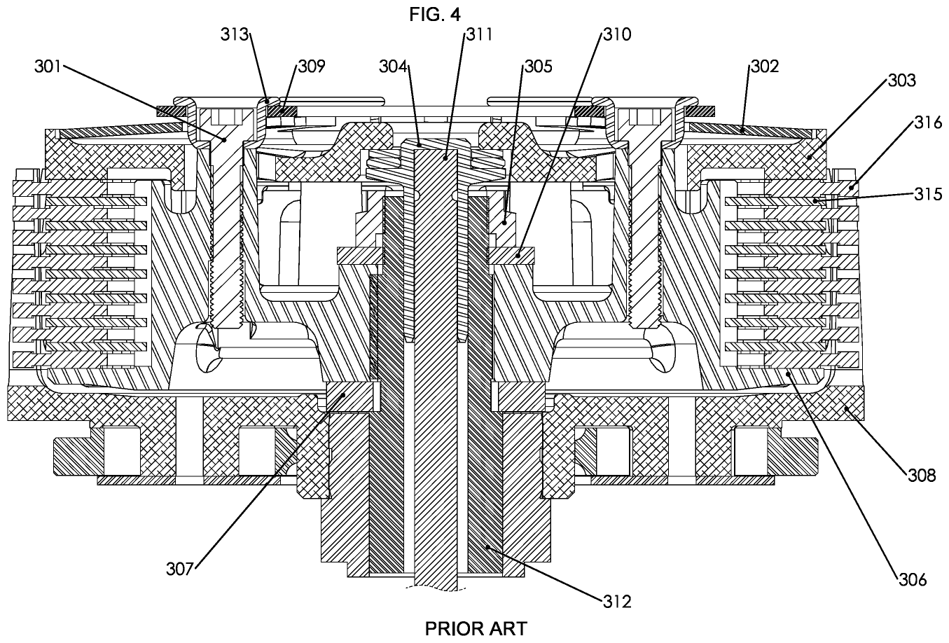

FIG. 4 is a section view of the prior art clutch shown in FIG. 3. As best seen in FIG. 4, the clutch pack 320 is comprised of eight friction disks 316 and seven drive plates 315. The clutch pack 320 establishes the distance between the pressure plate flange face 302 and center clutch flange face 305. The Bellevue spring (or diaphragm spring) 302 acts on the pressure plate 303 to compress the clutch pack 320 forcing the adjacent surfaces of the friction disks 316 and drive plates 315 to become coupled rotationally and in turn coupling the basket 308 and center clutch 306 rotationally. The throw-out 304 is coupled to a clutch disengagement system (not shown). The clutch disengagement system (not shown) is operable to selectively position the throw-out 304 for the purpose of pushing the pressure plate 303 away from the clutch pack 320 to disengage the clutch. Alternatively, the clutch disengagement system (not shown) is operable to selectively position the throw-out 304 for the purpose of returning the pressure plate 303 into contact with the clutch pack 320 to engage the clutch.

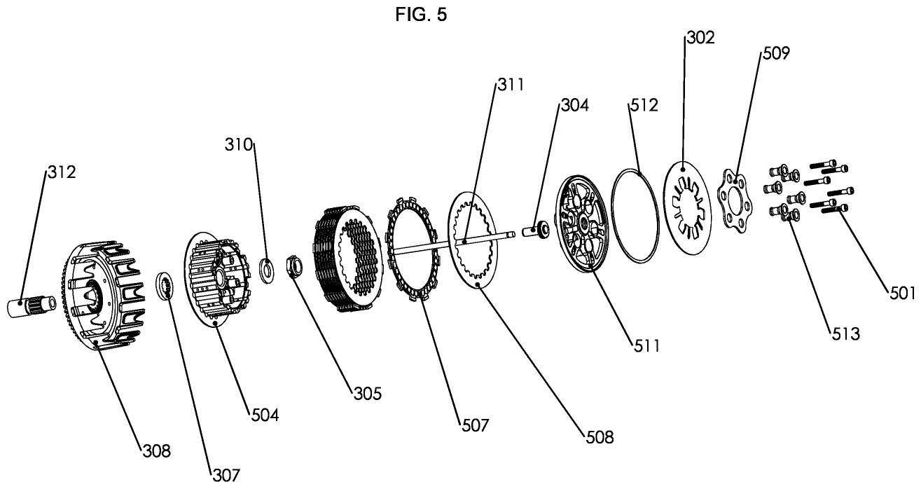

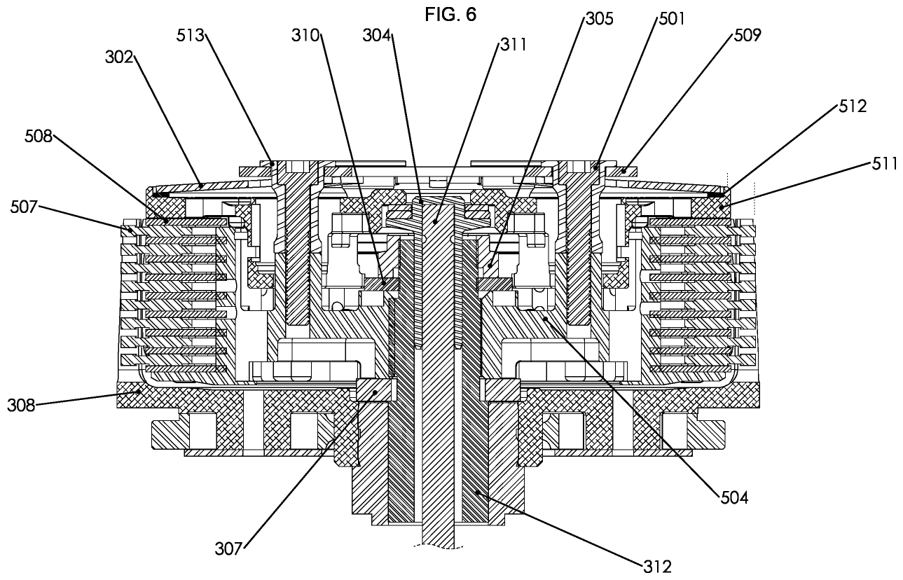

FIG. 5 illustrates an improved pressure plate 511 it is configured to operate with either or both of a Bellville spring and a series of coil springs. FIG. 5 depicts an exploded view of a clutch pack utilizing a center clutch 504 that is operatively connected with a clutch pack that is actuated by the improved pressure plate 511. In the depicted embodiment the pressure plate 511 is shown with a Bellville spring 302 serving to bias the pressure plate toward the clutch pack, thus biasing the series of friction discs 507 and drive plates 508 together, thus rotationally coupling the center clutch and the clutch basket 308. A spring seat 512 seats on the improved pressure plate to which the diaphragm or Bellville spring 302 is seated. A spring hold down ring 509 holds down the diaphragm spring downward onto the pressure plate to compress the clutch pack. A series of spring seats 503 inserts through the spring hold down ring 509 and are coupled to the center clutch by spring bolts 501. FIG. 6 illustrates a section view of the exploded clutch assembly of FIG. 5.

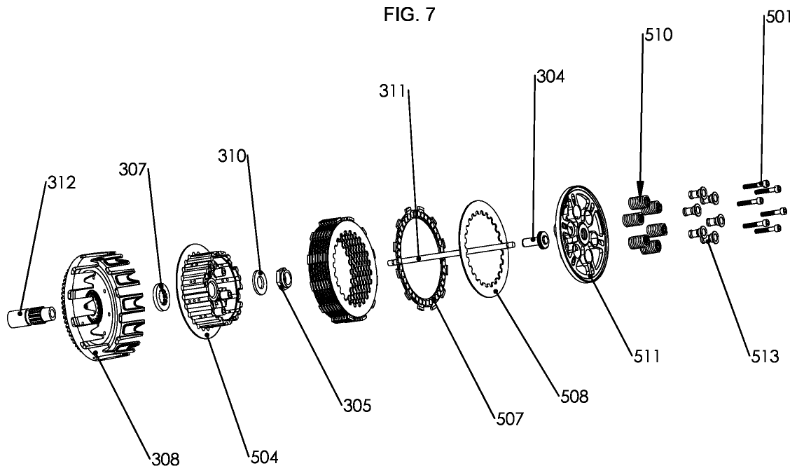

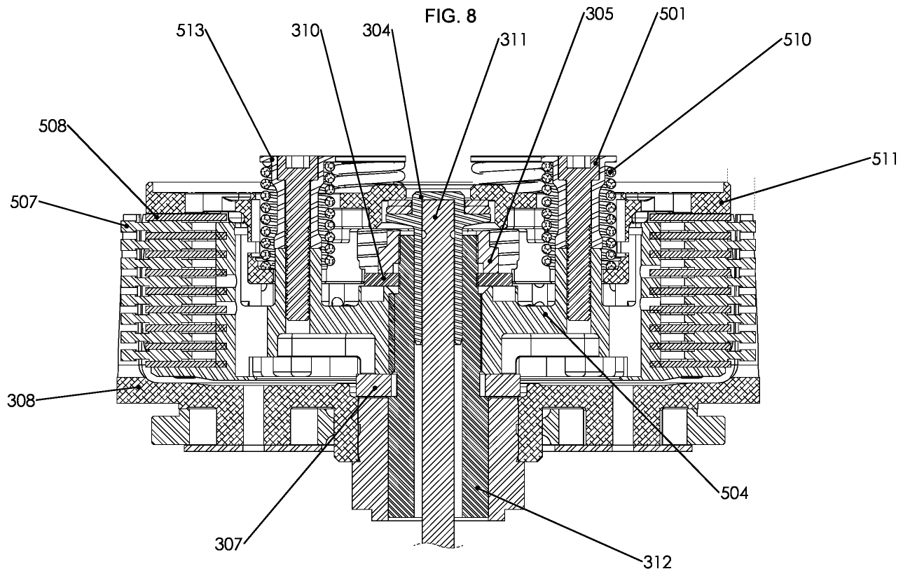

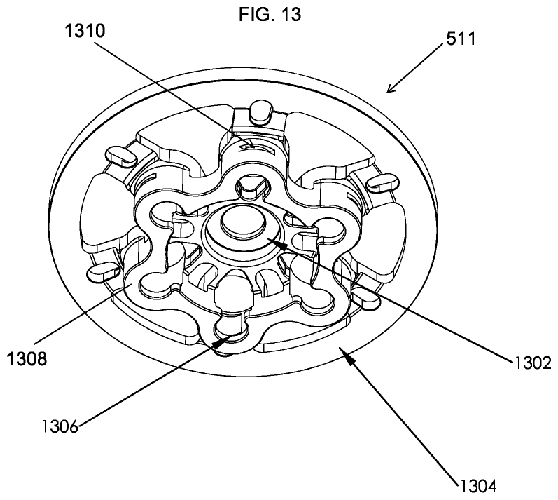

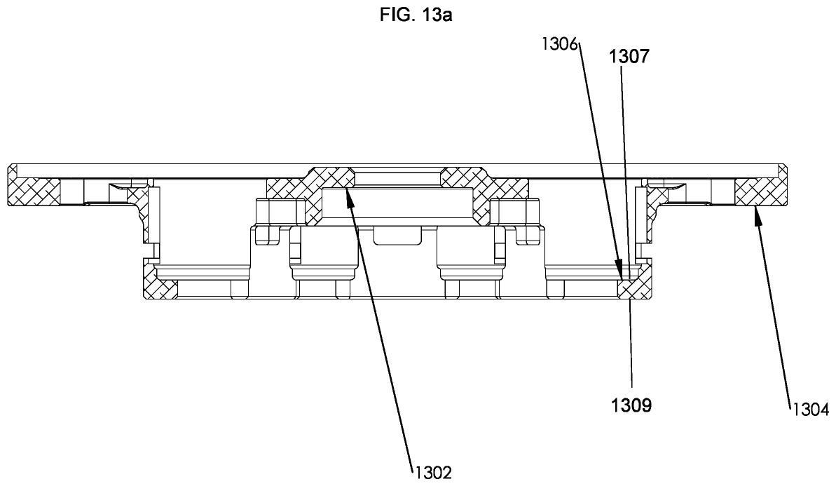

FIG. 7 illustrates the clutch of FIGS. 5 and 6 utilizing coil springs 510 without the Belleville spring. The coil springs are positioned within the coil spring cups (shown in further detail in FIG. 13). The spring seats provide a seat against which the spring extends to provide pressure to the pressure plate, with a first end of each spring seated against the spring seat, and a second end of the spring seated against the pressure plate such that the force of the spring biases the pressure plate toward the clutch pack. Spring bolt 501 connects the spring seats to the clutch center pack 504. FIG. 8 illustrates a section view of the assembled clutch assembly shown in FIG. 7.

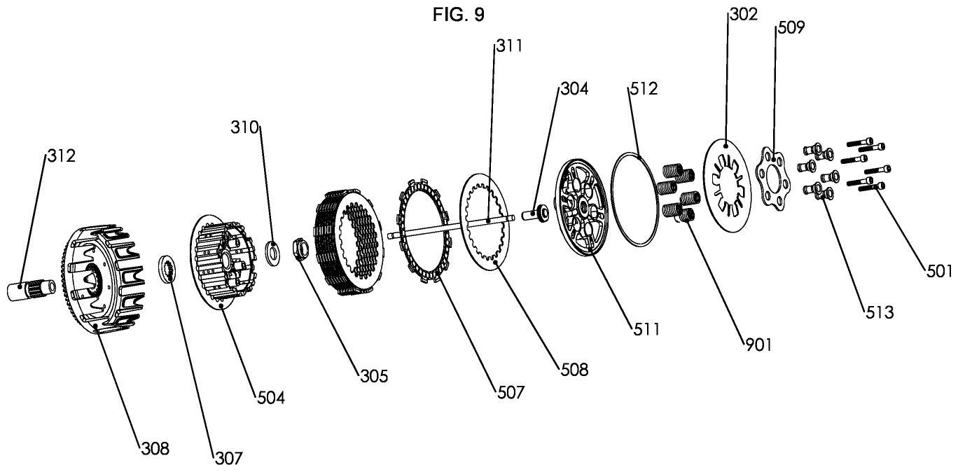

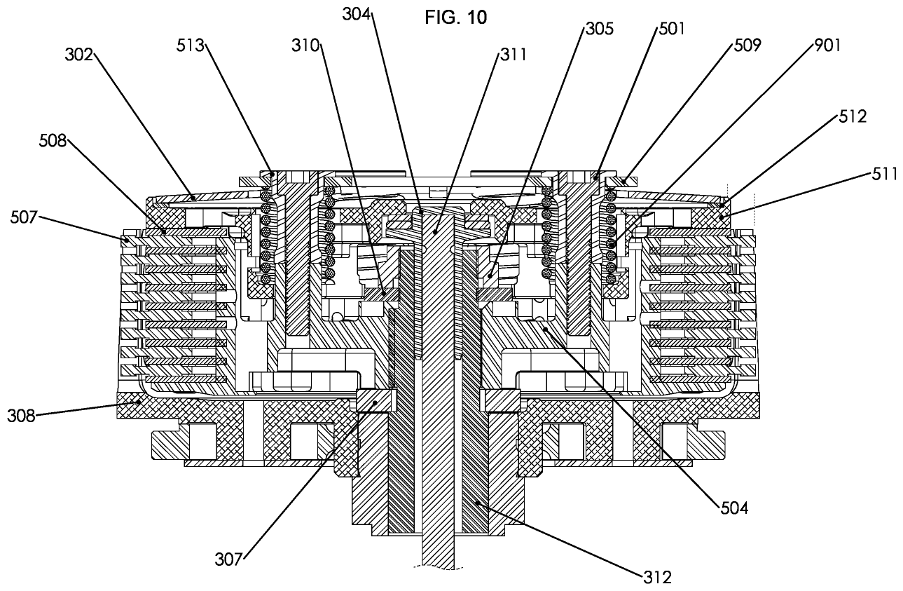

FIG. 9 illustrates a clutch assembly an exploded view of a clutch assembly utilizing both a series of coil springs 901 and a diaphragm or Belleville spring 302. The pressure plate is configured such that both a diaphragm spring 302 and a series of coil springs 901 can be utilized with the pressure plate. FIG. 10 illustrates a section view of the exploded clutch shown in FIG. 9.

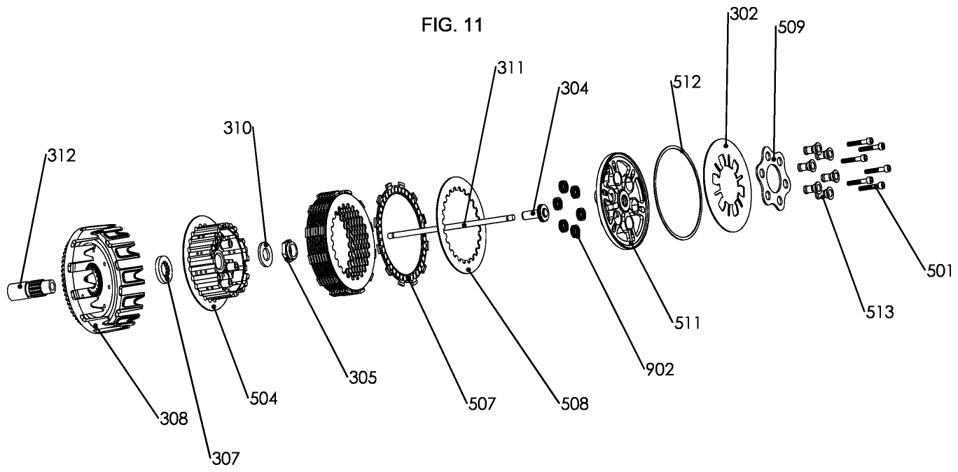

FIG. 11 illustrates an exploded view of a clutch assembly in which a diaphragm spring 302 is utilized similar to FIGS. 5 and 6. A series of wave springs 902 is utilized for tuning the Belleville spring. The wave springs 902 exert an opposing force to the biasing force of the Belleville spring, thus reducing the amount of pressure required from the clutch actuation device to overcome the Belleville spring.

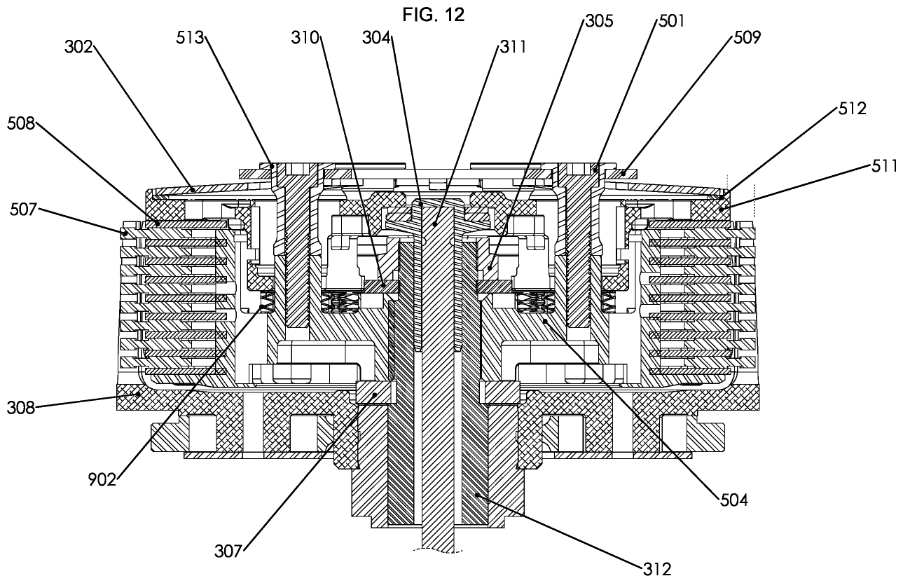

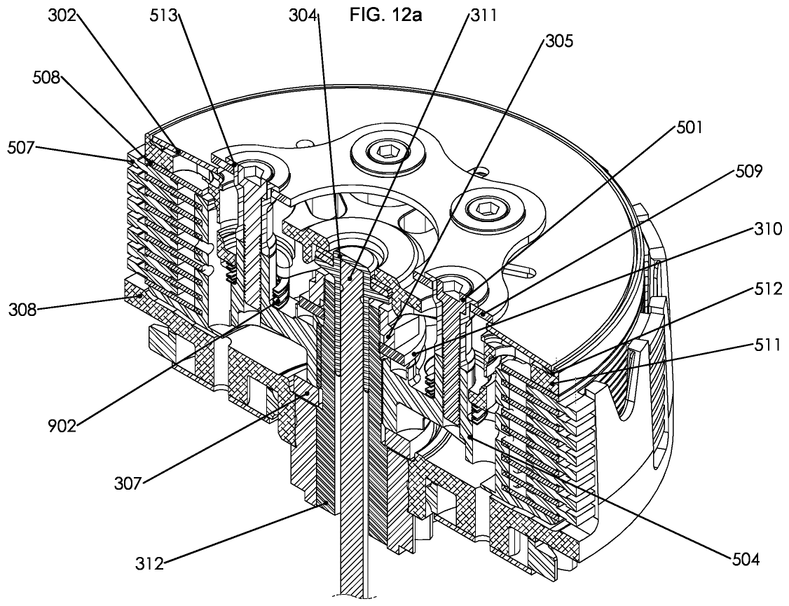

FIG. 12 illustrates a section view of the exploded clutch assembly of FIG. 11. FIG. 12 illustrates a perspective cross section view of a clutch of FIGS. 11 and 12. The wave springs 902 are shown compressed between the center clutch 504 and the periphery of the coil spring cup (1306 of FIG. 13). The wave springs provide an opposing force to the compressive force of the Belleville spring.

FIG. 13 illustrates a bottom perspective view of a preferred embodiment of an improved pressure plate according to the inventive concepts disclosed herein. FIG. 13 illustrates a pressure plate 511 provided in a disc shape. The pressure plate has a circumferential flange 1304 that is configured for placement of a Belleville spring seat (512 of prior figures). The illustrated pressure plate has a series of coil spring cups positioned radially inward on the pressure plate 511. The coil spring cups are positioned between the circumferential flange 1304 and a throw out bearing surface 1302. The throw out bearing surface is a flange formed proximate to the center of the disc. Each coil spring cup in the depicted embodiment is formed with a flange 1308 that provides for a first side surface against which a coil spring provides force to compress the pressure plate and clutch pack. Preferably the coil spring cups each has one or more slots 1310 or otherwise shaped openings configured for allowing the flow of lubrication, typically oil, through the wall of the coil spring cup. On the opposing side of the flange is a surface configured for a wave spring or other opposing biasing device to provide pressure and opposing force against the compression force of the coil springs and/or Belleville spring.

FIG. 13a illustrates a section view of the pressure plate of FIG. 12a. The opposing surfaces of the flange of the coil spring cup 1306 is shown. The upper surface 1307 provides a surface of which the coil spring exerts compressive force on the pressure plate and clutch pack the opposing surface 1309 provides an opposing surface against which a wave spring would be positioned.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

We claim:

1. An improved pressure plate for a vehicle clutch assembly operable with a clutch disengagement system, the improved pressure plate comprising:
a pressure plate having the shape of a disc, said pressure plate comprising features configured for operability with a diaphragm spring and a series of coil springs such that the diaphragm springs and coil springs are configured to exerts an oppressive force on the pressure plate such that the pressure plate compresses a clutch pack of a vehicle clutch in which said pressure plate is utilized.

2. The improved pressure plate of claim 1, wherein said features comprised a circumferential flange extending inward from an outer circumference of said disc and a series of coil spring cups positioned radially inward in said pressure plate from said circumferential flange.

3. The improved pressure plate of claim 2 wherein each of said coil springs cups comprises a compressive upper surface wherein said compressive upper surface is configured for an end of a coil spring to seat on said compressive upper surface such that said coil springs are configured to compress said pressure plate against a clutch pack of said clutch.

4. The improved pressure plate of claim 1 wherein said coil spring cups comprise a lower compressive surface, wherein a lower compression surface is configured to

[symbol]

5. An improved clutch assembly, said improved clutch assembly comprising:
a generally cylindrical clutch basket with sidewalls, a closed first end and an open second end, with said sidewalls made up of fingers and slots between the fingers;
a plurality of driving friction disks mounted in said clutch basket, each driving friction disk comprising a circular and planar disk with a hollow center portion, with a plurality of positioning tabs extending out from a periphery of each driving friction disks, configured to extend between said fingers, and each driving friction disks configured for frictional engagement with an adjacent driven friction disk;
a plurality of driven friction disks mounted in said clutch basket, each driven friction disk comprising a circular and planar disk with a hollow center portion, with a plurality of engagement tabs extending toward the center of said disks, for engagement with a center clutch which is configured to rotate in relation to said clutch basket, with each driven friction disks configured for frictional engagement with an adjacent driving friction disk;
a pressure plate having the shape of a disc, said pressure plate comprising features configured for operability with a diaphragm spring and a series of coil springs such that the diaphragm springs and coil springs are configured to exert a compressive force on the pressure plate to bias the clutch pack together to rotationally couple said center clutch and said clutch basket by said clutch pack, wherein said pressure plate is configured operationally coupled to a clutch actuation system such that actuation by said clutch actuation system causes a reverse force on said pressure plate to overcome said bias of said diaphragm spring and/or said coil springs.

6. The improved clutch assembly of claim 5, wherein said clutch actuation system comprises a throw out rod operationally connected to a clutch actuation lever, wherein said pressure plate comprises an opening at a center of said pressure plate defined by an annular ring formed in said pressure plate, wherein said annular ring comprises a throw out bearing surface configured for engagement with a throw out bearing connected to an end of said throw out rod.

7. The improved clutch assembly of claim 5, wherein said improved clutch assembly comprising at least one biasing device positioned between said center clutch and said clutch basket and configured to exert a force on said pressure plate opposite to said force exerted by said diaphragm spring and/or said coil springs to reduce the force required to actuate said clutch.

8. The improved clutch assembly of claim 7, wherein said biasing device comprises at least one wave spring.
